(19) United States
(12) Patent Application Publication
(10) Pub. No.: US 2009/0048548 A1
(43) Pub. Date: Feb. 19, 2009

(54) Power massage

(76) Inventor: George Tangonan Hernandez, III, Sunnyvale, CA (US)

Correspondence Address: George T. Hernandez III, 559 W. Eden Ave., Sunnyvale, CA, 94085, US

(21) Appl. No.: 12/079,806

(22) Filed: Jun. 16, 2008

Related U.S. Application Data
(60) Provisional application No. 60/921,133, filed on Mar. 30, 2007.

(51) Int. Cl. A61H 7/00; A61H 1/02

(52) U.S. Cl. 601/24; 601/134; 601/84

(57) ABSTRACT

A Power Massage uses a platform with a sliding block to permit length adjustment and maximizing lower body strength for the therapist. The platform may be attached to any model of massage therapy chairs. The platform may be in any shape and may be collapsed for ease of transportation by the therapist.

### CROSS-REFERENCE TO RELATED APPLICATIONS

This application claims priority under 35 U.S.C. § 120 of PCT Application No. 60/921,133 filed Mar. 30, 2007 titled “Power Massage” and is hereby incorporated by reference in its entirety. This application incorporates by reference in its entirety for all purposes U.S. Provisional Patent Applications Ser. No. 60/921,133, filed Mar. 30, 2007.

### FIELD OF THE INVENTION

This invention relates to a platform that attaches to any model of massage chair for enhancing the massage for the client and the therapist whom are of different sizes and weight to perform massage therapy at maximum strength and duration.

### BACKGROUND OF THE INVENTION

In order for the therapist to give a good massage, a considerable amount of force and strength must be exerted. As a therapist gives a massage while using the massage chair, a lot of strength exerted comes from the therapist's upper-body and hands. If excess force is exerted on the client's back, the back legs of a massage chair can actually lift off the ground which can create a dangerous condition. The power massage acts as both an anchor and a physical power generator so stability and more force can be exerted safely by the massage therapist, all while requiring less upper body strength.

### SUMMARY OF THE INVENTION

The power massage anchors to the back bottom legs of the massage chair. The device works with every massage therapy chair requiring only the customization of the chair attachment. The power massage then extends a platform which the therapist stands on. The weight of a therapist thus anchors the chair down to the floor.

On the platform is an adjustable sliding block that extends the width of the platform and adjusts to the entire length of the platform. Different coatings to increase friction can be applied to the varies materials used to make the platform. This adjustment allows for the varying lengths of the legs of a massage therapist.

The block is similar to what a sprinter uses at the start of a race. The massage therapist can thus brace on one foot against the starter block, and generate power from their lower body. The difference in force levels of a therapist and the ease which that force is generated represents an exponential leap for all massage therapists.

### BRIEF DESCRIPTION OF THE DRAWINGS

FIG. 1 A perspective view of the platform, foot brace, and chair attachment in the unfolded position.

FIG. 2 A bottom view of the platform in the unfolded position.

FIG. 3 A side view of the platform in the unfolded position.

FIG. 4 A top view of the platform in the unfolded position.

FIG. 5 A side view of the platform and the foot brace in the folded position.

FIG. 6 A side view of the platform, foot brace, and chair attachment in the unfolded position.

FIG. 7 A side view of the chair attachment.

FIG. 8 A front view of the chair attachment.

FIG. 9 A back view of the chair attachment.

FIG. 10 A front view of the track and guide bolt.

FIG. 11A front view of the track and guide bolt which depicts the guide bolt's spring mechanism in the un-retracted position

FIG. 12 A front view of the track and guide bolt which depicts the guide bolt's spring mechanism in the retracted position

FIG. 13/14 A side view of the foot brace.

FIG. 15 A front view of the foot brace.

FIG. 16 A back view of the foot brace.

FIG. 17 A top view of the platform and foot brace.

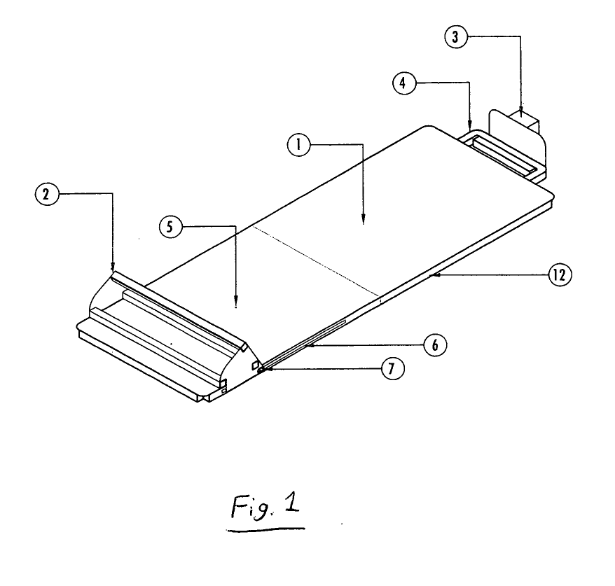

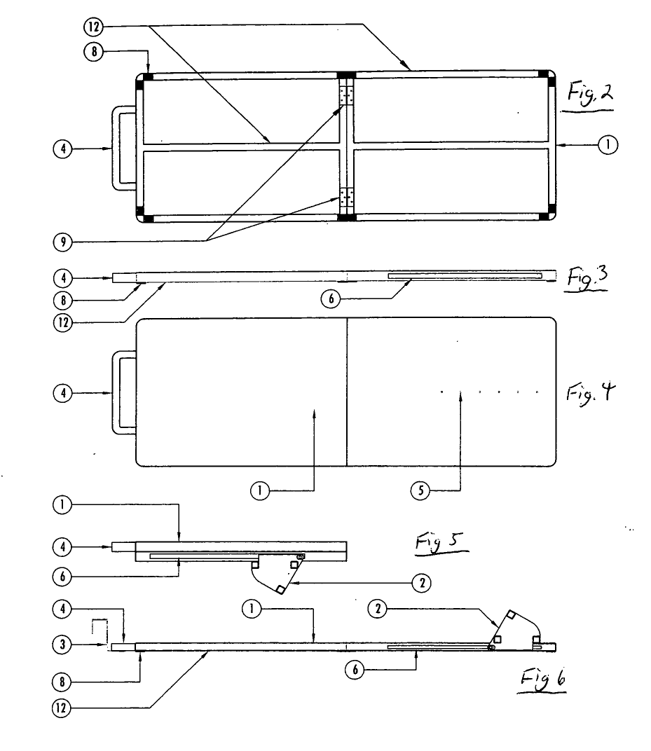

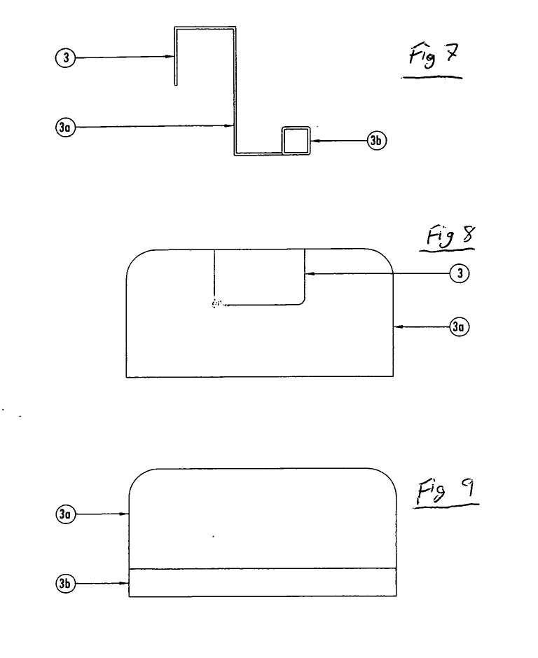

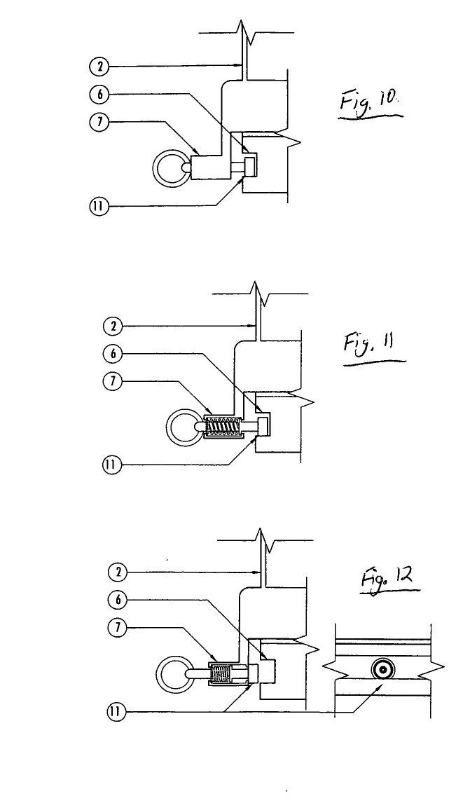

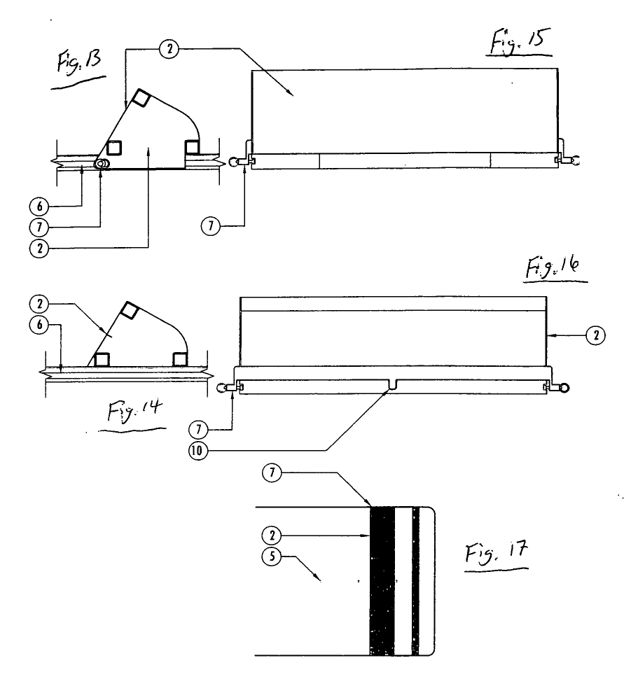

### DESCRIPTION OF THE PREFERRED EMBODIMENT

The Power Massage is comprised of three main components which are the platform 1, the foot brace 2, and the chair attachment 3.

The foot brace 2 is connected to the platform 1, via the foot brace guide bolts 7, attaching to the platform's tracks 6, and via the foot brace anchor arm 10, attaching to the platform's anchor holes 5.

The platform 1, is then connected to a massage chair via the chair attachment 3. The front of the chair attachment 3a, mounts onto a massage chair while the back of the chair attachment 3b, attaches to the handle 4 of the platform 1.

The front to the chair attachment 3a, hooks on top of the massage chair. The back of the chair attachment 3b, hooks underneath the handle 4, of the platform 1.

When the platform/foot brace assembly is attached to the massage chair, a therapist standing on the platform 1, and bracing himself against the foot brace 2, is able to exert force on the patient while the therapist's own weight on the platform 1, counteracts both the torque and translational forces naturally generated during normal massage therapy.

The underside of the platform 1, contains rubber pads 8, to resist movement and the underside can also be coated with material that increases the friction between the platform and the floor, thus increasing the platform's ability to resist translational forces.

The foot brace 2, is reinforced with three square tubes along its length to resist bending and deformation when a therapist applies force to the foot brace 2.

The platform is hinged 9, at the center to allow the platform to be folded in half for easy storage or transportation.

Six anchor holes on the platform 5, allow the therapist to change the position of the foot brace to accommodate therapists of different heights.

Metal tubing 12, on the underside of the platform 1, is used to reinforce the integrity of the platform 1.

1. A platform comprising:
(1.) a sturdy, non flexible material,
(a.) that is made of material able to withstand downward and translational force,
(b.) that conveniently collapses for ease of transport and storage, and
(2.) an attachment,
(a.) to the platform,
(b.) that connects to the legs of differing models of massage chairs,
(3.) a block,
(a.) locked onto the platform via restraints,
(b.) that is capable of being adjusted along the length of the platform and
(4.) hinges on the platform that allows convenient collapsing for storage or transportation.
